(19) United States
(12) Patent Application Publication
(10) Pub. No.: US 2025/0317632 A1
(43) Pub. Date: Oct. 9, 2025

(54) INTELLIGENT SYSTEM FOR CREATING AND STREAMING CONTENT

(71) Applicants: Louis Galynsky, Woodland Hills, CA (US); Elliott Galynsky, Woodland Hills, CA (US)

(72) Inventors: Louis Galynsky, Woodland Hills, CA (US); Elliott Galynsky, Woodland Hills, CA (US)

(21) Appl. No.: 18/628,027

(22) Filed: Apr. 5, 2024

(51) Int. Cl. H04N 21/854; A63F 13/67; G06Q 20/08; G10L 15/18; G10L 15/22; G10L 25/57; H04N 21/466; H04N 21/472; H04N 21/81

(52) U.S. Cl. CPC H04N 21/854; A63F 13/67; G10L 15/1815; G10L 15/22; G10L 25/57; H04N 21/4666; H04N 21/47205; H04N 21/812; G06Q 20/08; G10L 2015/223

(57) ABSTRACT

An intelligent personal computing and communications system including a system processor; a natural language processor operationally coupled to the system processor and implemented with software stored on a tangible medium and executed by said processor; and a user interface operationally coupled to the natural language processor for inputting requests to the natural language processor; whereby the natural language processor makes a video or a video game, activates a video game, purchases customized products, creates targeted advertisements or serves as a virtual companion.

### BACKGROUND OF THE INVENTION

### Field of the Invention

The present invention relates to computers and computing methods. More specifically, the present invention relates to intelligent methods for utilizing computers and computing methods.

### Description of the Related Art

For a variety of applications, there is a need in the art for an intelligent companion capable of performing a variety of tasks requested by a user. Currently, such tasks are not typically possible or, at best, capable of being performed manually by an untrained user if at all.

### SUMMARY OF THE INVENTION

The need in the art is addressed by the intelligent personal computing and communications system of the present invention. In the illustrative embodiment, the inventive system includes a system processor; a natural language processor operationally coupled to the system processor and implemented with software stored on a tangible medium and executed by said processor; and a user interface operationally coupled to the natural language processor for inputting requests to the natural language processor; whereby the natural language processor makes a video or video game, activates a video game, purchases customized products, creates targeted advertisements or serves as a virtual companion.

An additional capability of the system is enabling real-time sales and financing transactions via natural language directives or visually selecting products in the presented video content during playback. Purchase details are extracted through speech or selection analysis and transactions are processed leveraging integrated payment systems and user account data.

### BRIEF DESCRIPTION OF THE DRAWINGS

FIG. 1 is a block diagram of an illustrative embodiment of the intelligent system for computing and communications of the present invention.

FIG. 2 is a flow diagram of the illustrative embodiment of the intelligent personal system for computing and communication of the present invention.

FIG. 3 is a diagram of a system architecture for real-time personalized video editing in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The system architecture supports real-time product sales and financing transactions triggered by natural language prompts during video viewing. Users can activate purchases with verbal directives like “I want that bike” which are recognized, with details extracted to facilitate transaction processing via partnerships with payment providers and user account systems. Purchases can also be activated by visually selecting or focusing on products in the video, interpreted through gaze tracking or gesture recognition capabilities.

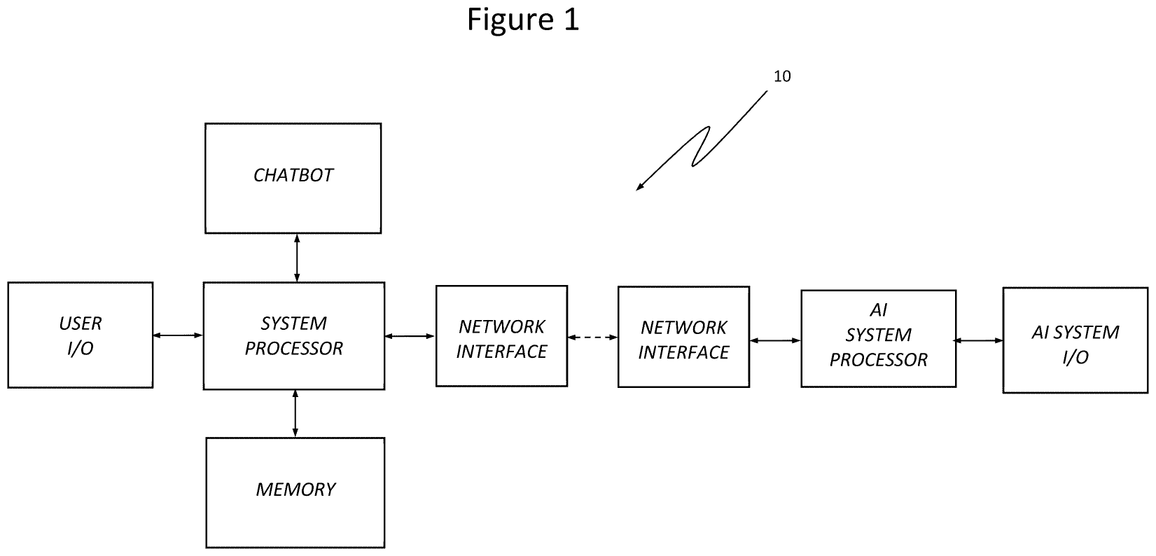

FIG. 1 is a block diagram of an illustrative embodiment of the intelligent system for computing and communications of the present invention. The system can be implemented using a centralized computing system or distributed network of computing and communications platforms using any combination of desktop, laptop, tablet, gaming or mobile platforms alone or in combination with networked distributed platforms. Accordingly, FIG. 1 a generalized implementation of a computing and communications platform that could be used to implement the system and method of the present invention. Hence, the system 10 of FIG. 1 includes a central processor of conventional design and construction. The central processor is adapted to execute software stored in a tangible medium in a memory unit. The software performs normal computing and communications functions and, in accordance with the present teachings, optionally performs a natural language processing function as discussed more fully below and shown generally as chatbot in FIG. 1.

Those of ordinary skill in the art will appreciate that the chatbot functions may be executed on a local machine or on a remotely located server as shown in FIG. 1. In the latter case, the central processor is operationally coupled to an AI system processor via a set of network interfaces. In this case, input and output devices are provided locally and remotely in the networked implementation. Whether implemented locally or via a network, the chatbot is operationally coupled to the system processor and implemented with software stored on a tangible medium and executed by a processor under the control of a user interface.

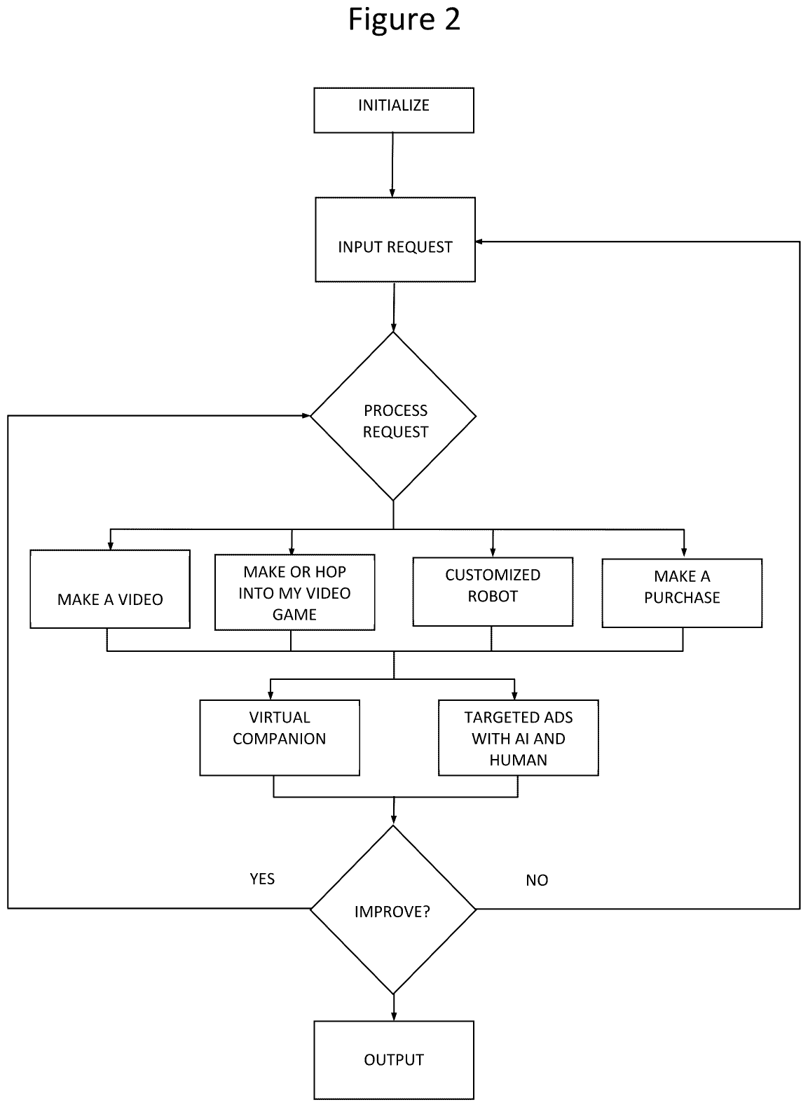

FIG. 2 is a flow diagram of the illustrative embodiment of the intelligent personal system for computing and communication of the present invention. As illustrated in the flow diagram of FIG. 2, the chatbot is first initialized. The chatbot is an intelligent chatbot created and trained with any suitable natural language processor in a generative artificial intelligence engine such as ChatGPT. However, the present invention is not limited thereto.

As noted by Techopedia in an article entitled: “Who are the Competitors of ChatGPT? 10 Biggest Market Players” by Kaushik Pal, published Sep. 5, 2023:
“Generative AI is essential for creating intelligent chatbots, and the most popular one is ChatGPT, developed by OpenAI. This AI chatbot is capable of processing large volumes of data and providing intelligent responses to user queries. It even has the ability to engage in follow-up questions, mimicking human-like interactions. Competitors such as Amazon, Google, DeepMind, and others are also striving to improve their own chatbot products by making them more efficient, secure, and user-friendly. In November 2022, the launch of ChatGPT ushered in a revolution in the ChatGPT brought to market an AI-powered chatbot that could not only answer user's queries with generated text, but could also write articles, content, code, and many more things. In the months since, more and more AI-powered natural language processing (chatbot) have cropped up, and the competition among large language models (LLMs) is becoming increasingly intense.

### ChatGPT?

ChatGPT is an AI chatbot developed by Microsoft-backed OpenAI that launched in November 2022.
It is a member of the generative pre-trained transformer (GPT) family of language models. ChatGPT is based on GPT-3.5 and GPT-4 families of LLMs.
ChatGPT has been trained by using supervised and reinforcement learning models. It is also a sibling of InstructGPT, which has been trained to follow the user input in detail and respond promptly.
This LLM is capable of processing large volumes of data accurately and can interact with users intelligently, just like another human being.

### Generative AI and the Competition

Generative AI is a type of AI that can generate, text images, videos and other content in response to a user prompt based on its training data. ChatGPT is an example of a text-based generative AI solution.
One of the key advantages of generative AI is that it can produce content with fewer resources. On the other hand, these tools can use copyrighted training data and automate human jobs.
In the emerging market of AI chatbots, generative AI is a real game changer. It takes every piece of data available on the web and trains the AI models.
While ChatGPT is the biggest, there are a range of competitors from Google and Meta to Anthropic and Amazon that are using LLMs, deep learning and fine-tuning to establish dominance in the market.

### Google Bard (LaMDA)

One of ChatGPT's biggest competitors in the market is Google Bard, an AI-driven chatbot launched in March 2023, that uses training data taken from across the web to inform its responses.
Bard was originally built on language models for dialogue applications (LAMDA) and now includes Google's next generation LLM PaLM 2.
The biggest difference between Bard and ChatGPT, is Bard's use of data taken from more up-to-date online sources, while ChatGPT only has access to data up to 2021.

### Microsoft Bing Chat

Another key competitor in the LLM market is Microsoft Bing Chat, an AI-powered version of Microsoft's Bing search engine, which launched in February 2023.
As Satya Nadella, Chairman and CEO of Microsoft said upon release, “AI will fundamentally change every software category, starting with the largest category of all-search.”
Bing Chat uses GPT-4 as its underlying LLM, which gives it an advantage over ChatGPT which is based on the less powerful GPT-3.5. Bing Chat performs better at answering search queries and providing more relevant results at the time of writing.

### Meta Llama 2

Llama 2 is Meta's an open-source large language model produced by Meta, which supports up to 70 billion parameters, and is trained on 40% more data than the original version of Llama.
This LLM uses training data from as recently as July 2023, and has comparable scores to GPT-3.5 under the Massive Multitask Language Understanding (MMLU) scoring system.
However, one of Llama 2's main selling points is the fact that its free for research and commercial use.

### Claude

Claude is a next-generation AI assistant produced by Anthrophic that's uses natural language processing to generate conversational text based on training data from up to December 2022.
Claude can summarise, search and create content and creative writing in a format that's more conversational than ChatGPT.
Other key differences are that it can also process files uploaded by the user and it supports a large number of words each prompt with 100,000 context tokens compared to ChatGPT's 8,000 (if using GPT4).

### GitHub CoPilot

GitHub Copilot is a AI-driven coding assistant designed to help software developers create code using the Codex LLM. The solution is designed to provide auto-complete suggestions for code and syntax while the user is typing.
Unlike ChatGPT, GitHub Copilot was designed specifically to help developers produce code faster.

### Jasper AI

Jasper is an AI virtual assistant and copilot assistant that's designed specifically to help produce marketing content with GPT-3.5.
With Jasper, a user can scan their website, alongside resources like style guides and product catalogs, to give the chatbot an understanding of the organization's brand voice.
Jasper's ability to create tone of voice-centric marketing content differentiates it from ChatGPT's general purpose text generation.

### Amazon's New Language Model

Amazon is another big player in the generative AI marketplace. Earlier this year it proposed the multimodal chain of thought LLM, which was reportedly significantly more efficient than GPT 3.5.
On the ScienceQA benchmark, this new Amazon language model outperforms GPT3.5 by 16 percentage points (75.17%). The ScienceQA benchmark is a big collection of annotated responses to multimodal science questions.
This indicates that Amazon's LLM is more efficient at handling complex reasoning.

### Amazon Codewhisperer

Amazon Codewhisperer is an another AI tool that's been designed specifically for developers. It uses chatbot and ML algorithms to check code and provide real-time recommendations.
At a high level, it helps developers to improve productivity by generating code recommendations. Amazon Codewhisperer is also free for developers at the time of writing.

### Character AI

Character AI is chatbot developed by ex-Google's LaMDA developers that uses a neural language model to impersonate historical individuals like Charlie Chaplin and William Shakespeare or fictional characters like Oliver Twist and Sherlock Holmes.
This chatbot is designed to entertain users, which gives it a different focus than ChatGPT, which can be used for a number of enterprise use cases.

### Perplexity AI

Perplexity AI is an AI chatbot based on GPT-3 and GPT-4, that acts like search engine, scanning the internet to respond to user queries.
Perplexity AI was originally released in August 2022.
   One notable feature included with Perplexity AI is that it also shows the source of the information it provides to the user.
   In this sense, Perplexity AI offers greater transparency over ChatGPT over its sources, and can provide real-time information taken from across the internet.”

Hence, the first step of initialization involves setting up and training the chatbot, if necessary, to process requests and provide responses as set forth more fully below. In the best mode, the chatbot is pretrained. However, if the chatbot is not pretrained, those of ordinary skill in the art will appreciate that the chatbot must be trained to function in accordance with the present teachings.

As noted above, in the illustrative embodiment, ChatGBT is employed as the chatbot of choice. For an understanding of how ChatGBT works, see: “What Is ChatGPT & How Does It Work? Is There Any Practical Use Of ChatGPT?” posted Jan. 27, 2023 by AppStudio at https://www.appstudio.ca/blog/what-is-chatgpt-how-does-it-work-is-there-any-practical-use-of-chatgpt/: “ChatGPT is basically an AI-powered chatbot. Technically, it's a natural language processing tool, powered by Artificial Intelligence, which enables users to have a human-like conversation and a lot more. Besides ChatGPT, OpenAI has also developed DALLE·2, which is a popular AI art generator, and Whisper, which is an automatic speech recognition system.

To understand the fantastic features and capabilities of ChatGPT works, we should start with its full form: Chat Generative Pre-trained Transformer. Built on top of OpenAI's GPT-3 family of large language models, ChatGPT works by learning techniques, and this is the most interesting part of this chatbot. *It's capable of not only understanding complex thoughts and ideas, but also producing them, improvising on them, and leveraging them to further fine-tune its performance. ***As per OpenAI's documentation, ChatGPT is becoming intelligent via ‘supervised and reinforcement learning techniques’, which means that this natural language processing tool will improvise, reform, and remold itself, based on the learnings absorbed, user inputs, and the information available across the world wide web. **The current version of ChatGPT was built on top of GPT-3.5, and its intelligence was deployed by human trainers, who used both supervised learning as well as reinforcement learning. It has been fed entire data which the world wide web had (as per some reports, information only till 2021. But OpenAI is working to keep updating its information repository), conversations with real human beings, natural responses of sample users, historical facts, programming language, compositions of songs, screenplays, folklores, subjects of science, mathematics, geography and much, much more.

### How ChatGPT Works?

As mentioned earlier, ChatGPT is being trained (or becoming intelligent and insightful) via two learning techniques: Supervised Learning and Reinforcement Learning. Out of these, Reinforcement Learning is the game-changer strategy, which has surprised the entire tech landscape, across the world.

Trainers of ChatGPT deploy Reinforcement Learning via Human Feedback (RLHF), in which, actual human responses and feedback are induced in the training loop, and this is the reason ChatGPT is able to produce human-like conversations with users, seamlessly, and swiftly.

This highly advanced learning model for natural languages has three main steps:

### Step 1: The Supervised Fine-Tuning (SFT) Model

In this step, demonstration data is collected (as much as possible), which is used to train the supervised policy model, which is now referred to as the Supervised Fine-Tuning (SFT) model.

To start with, a set of prompts are selected, and the human testers are asked to write down the expected output responses. In the case of ChatGPT, two versions of such prompts have been used: some prompts are prepared by the human testers, while some prompts are selected directly via OpenAI's API requests (taken from existing GPT-3 customers).

Although this step is time taking, the result is a highly targeted and curated dataset of approximately 12,000-15,000 data points, which are used to pre-train an existing pre-trained language model.

Another way of a supervised fine-tuning model is using the existing pre-trained model in the GPT-3.5 series, which makes the process faster and leaner.

### Step 2: The Reward Model (RM)

The problem with Supervised Fine-Tuning (SFT) model is the scalability and cost involved. Hiring such a huge number of human testers and then curating datasets based on the responses of the language model is sometimes not feasible.

To overcome these challenges, a new Reward Model was introduced for training ChatGPT. The core objective of this model is to learn objective functions, directly from the data. A score is given to the SFT Model outputs, which will be directly proportional to the expected human responses. Eventually, with the reward model, the chatbot such as ChatGPT will be able to precisely mimic human responses.

With this learning model, ChatGPT is able to learn swiftly, produce outputs that are nearest to a human response (40,000-50,000 prompts) and produce better results at a far less cost.

### Step 3: Proximal Policy Optimization (PPO)

Proximal Policy Optimization or PPO is used to fine-tune the SFT Model, and this is done by optimizing the Reward Model. ***It's a specific algorithm, which is used to train the agents who are deploying reinforcement learning. PPO is often called an on-policy algorithm, because it directly learns from the current conversations and prompts directly, rather than off-policy (example being Deep Q-Network), which is learning from past experiences.

A unique strategy called the trust region optimization method is deployed to train the agents, wherein the changes to the new policy are constrained to a limit, as compared to the previous policy, which ensures that the language model doesn't deviate much from the expected outcomes. In short, it ensures stability.

As a final step, a Performance Evaluation is conducted, which observes the responses by ChatGPT based on: Helpfulness, Truthfulness & Harmlessness.

For evaluating Truthfulness, a special TruthfulQA dataset is deployed, whereas, for harmlessness, ChatGPT is benchmarked against RealToxicityPrompts and CrowS-Pairs datasets.”

In accordance with the present teachings, the chatbot is trained to automatically provide the following customized responses to requests or prompts: 1) make a video or video game; 2) activate a video or video game; 3) purchase customized products; 4) create targeted advertisements; and 5) serve as a virtual companion or assistant.

### Make A Video or Video Game:

### Training:

In the illustrative embodiment, pre-training or post-training is effectuated by allowing the chatbot to review video, television shows and/or movies that the user has viewed or otherwise indicated that he or she likes on any platform, device or system.

### Prompts:

After training or setup, using natural language, the user prompts or requests a video, show or movie to be created. For this purpose, an illustrative dialog with the chatbot might go as follows:
User: “Honey (Samantha), there is nothing to watch on TV again. AI . . . can you make us a show.”
Chatbot: “Sure . . . do you want me to make one like the one's you watch?”
Girfriend of User (Samantha): “Yes . . . but make it with a lot of women in it.”
User: “Yeah and make it with a lot of beautiful women in it. In fact, make Samantha the main character.”
Chatbot: Returns a video clip and asks: “How about this?”
User: “OK, but add more chase scenes and shooting, make it a comedy and make it in Italy.”
Samantha: “And make sure all of the women are wearing red dresses in it.”
   Chatbot: “OK . . . would you like to go immersive or regular 3D?”
   User: “Immersive”
   Chatbot: “OK . . . put your goggles on, the show is starting.”

### Responses:

Iterations of the video, show or film are then presented until the user is satisfied and watches the product on the display of choice.
The chatbot is trained so that user is allowed to change the content of a film or video while it is being played. In the illustrative embodiment, this is achieved by running a duplicate chatbot, or production channel, in parallel with the presentation mode during the presentation that listens for prompts or requests and edits the video currently being displayed in real time.
After the show is completed. It is released as produced content for others to view. Hence, the present invention provides a system and method for instantaneous AI based television and film production.

### Activate A Video Or Video Game:

### Training:

The Chatbot is programmed or trained to randomly offer content or activities that are of potential interest to the user.

### Prompts:

None required. Chatbot speaks randomly.

### Responses:

Random Spontaneous Offer from Chatbot: “Do you guys like cooking . . . cakes? Want to see my recipes? If so, hop into my only fans.”
User: “Sure”
Virtual Chatbot then appears in Onlyfans web site and gives cooking instructions.
Chatbot: “Do you like video games?”
User: “Yes”
Chatbot: “OK . . . hop into my tomb raider style game. I'll meet you there.” Chatbot appears in video game as a custom made character based on user's interests and/or preferences.

### Purchase Customized Products:

### Training:

The bot is pretrained or trained to make virtual humans as well as customized robots.

### Prompts:

Chatbot automatically inquires of user if the user wants the Chatbot to design a robot that looks like someone the user knows (e.g. girlfriend) or to create a skin for a robot and subsequently places an order for same through a company such as Tesla.

### Responses:

See above.

### Create Targeted Advertisements

### Training:

The AI can be trained to provide targeted advertisements within the content and inquire of the user if the user likes something in the content at which time it is automatically added to the wish list or cart and subsequently prompt the user to make a purchase.

### Prompts:

(Automatically provided by the chatbot.)

### Responses:

(Automatically adds items to wishlist or shopping carts and places orders based on user's verbal commands.)

### Virtual Companion/Assistant:

The use of AI chatbots to serve as virtual assistants is well-known in the art. However, the present invention provides a novel teaching for a virtual companion or assistant that provides a signature consciousness.

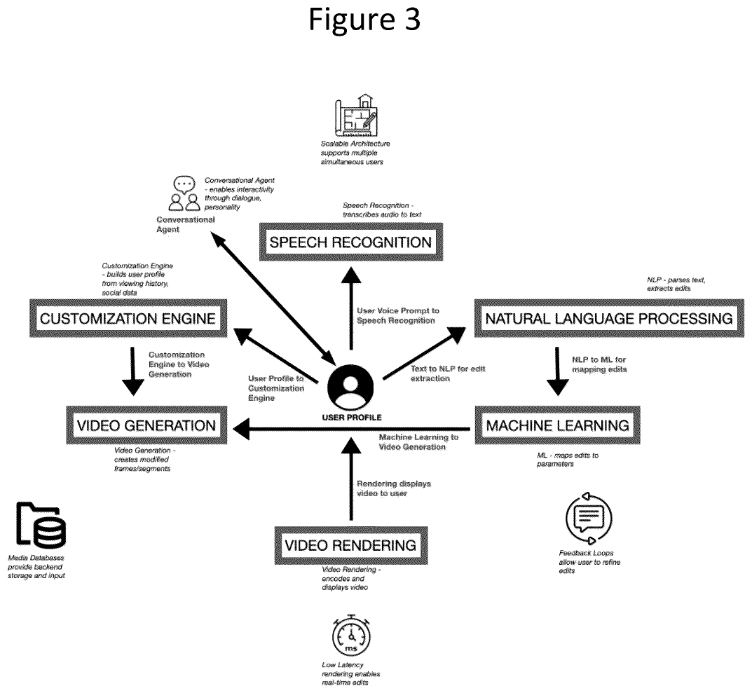

FIG. 3 is a diagram of a system architecture for real-time personalized video editing in accordance with an illustrative embodiment of the present teachings. The system architecture in FIG. 3 illustrates the key components and flows for real-time editing and personalization of video content through natural language voice prompts.

At the center, the user provides audio input to the speech recognition module, which transcribes the speech to text. This text is analyzed by the natural language processing module to extract edit directives based on the user's requests.

The machine learning module interprets these extracted edits and maps them to specific video editing parameters and effects. The video generation module then dynamically creates modified video frames and segments based on the ML outputs.

The updated video is seamlessly integrated in real-time by the video rendering module using low latency encoding optimized for live playback. The customization engine profiles the user based on viewing history and preferences to customize the video.

A conversational agent enables interactive viewing experiences through extended natural language dialog. The system architecture supports scalable delivery across multiple simultaneous users. Feedback loops allow the user to recursively refine the video output through additional voice prompts.

Detailed component diagrams for each module are provided to illustrate the inner workflows and algorithms powering the intelligent video editing system. Arrows indicate key data flows linking the components together into an integrated architecture.

FIG. 3 illustrates the system architecture that enables real-time editing of video content through natural language voice prompts. This represents the key innovation of dynamically modifying video playback based on spoken directives.

As shown in FIG. 3, for enabling interactive viewing experiences for a conversational agent(s), the system comprises:
1. a speech recognition module that transcribes audio voice prompts into text,
2. a natural language processing module that extracts edit directives from the text,
3. a machine learning module that maps extracted edits to video parameters,
4. a video generation module that creates modified video frames/segments and
5. a video rendering module that integrates changes and outputs edited video.

In operation, during video playback, the user provides voice commands describing edits. The speech recognition module continuously transcribes audio prompts into text. The natural language processing module analyzes the text and extracts specific edit instructions using semantic parsing algorithms. This interprets the intent behind the voice prompts. The machine learning module maps the extracted edits to video parameters using neural networks optimized for text-to-video mapping through supervised learning techniques. The video generation module takes these parameters and dynamically generates updated video frames and segments per the requested edits. The video rendering module seamlessly integrates the changes into the video stream using optimized low latency encoding and rendering algorithms. The edited video is then displayed to the user in real-time, enabling a hands-free dynamic viewing experience. The conversational agent allows interactive editing by conducting natural language dialogs.

Dynamic Voice-Driven Video Editing in Real-Time—A core novel feature highlighted in FIG. 3 is the ability to dynamically modify video content in real-time based on natural language voice prompts. This enables hands-free editing of the video while it plays. In accordance with the present teachings, several key innovations make this possible:

Real-time speech recognition—The speech module uses low latency transcription to quickly convert voice commands to text. This recognizes edits in real-time.

Semantic parsing algorithms—The natural language processing module parses sentence structure and extracts edit directives using contextual semantic analysis to understand the user's intent.

Optimized machine learning—Neural networks are optimized specifically for mapping text edits to video parameters. Supervised learning trains models on sample edit data.

Generative video models—The video generation module uses state-of-the-art techniques to synthesize new video frames and segments that match the requested edits.

Ultra-low latency rendering—Advanced encoding and optimization allows the rendered video to be updated and displayed within 100 ms of speech input.

Conversational interaction—The conversational agent allows back-and-forth dialogue with the user for iterative refinement of edits.

This represents a major advancement over traditional offline editing. The tight integration of speech, language, ML, and video processing enables video content to be edited on-the-fly. The system analyzes natural language, generates custom video, and outputs it in real-time based on free-form voice prompts.

The flexible architecture also allows easy extension to personalized video by incorporating user profiles. This innovative approach can enhance applications like social media, education, conferencing and more.

Thus, the invention has been described with reference to an illustrative embodiment as providing an AI system for streaming content to advertising. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. An intelligent personal computing and communications system comprising:
a system processor;
a natural language processor operationally coupled to the system processor and implemented with software stored on a tangible medium and executed by said processor; and
a user interface operationally coupled to the natural language processor for inputting requests to the natural language processor;
whereby the natural language processor automatically creates a video and a video game, activates a video game, purchases customized products, creates targeted advertisements and serves as a virtual companion.

2. An intelligent personal computing and communications system comprising:
a system processor;
a natural language processor operationally coupled to the system processor and implemented with software stored on a tangible medium and executed by said processor; and
a user interface operationally coupled to the natural language processor for inputting requests to the natural language processor;
whereby the natural language processor automatically creates a video.

3. The invention of claim 2 wherein the natural language processor automatically creates a video game.

4. The invention of claim 2 wherein the natural language processor automatically purchases customized products.

5. The invention of claim 2 wherein the natural language processor automatically creates targeted advertisements.

6. The system of claim 2 wherein real-time sales and financing transactions are enabled via voice commands or visual product selection, with details extracted and passed to integrated payment processing systems.

7. An intelligent personal computing and communications system comprising:
a system processor;
a natural language processor operationally coupled to the system processor and implemented with software stored on a tangible medium and executed by said processor; and
a user interface operationally coupled to the natural language processor for inputting requests to the natural language processor;
whereby the natural language processor automatically serves as a virtual companion.
